(19) United States
(12) Patent Application Publication
(10) Pub. No.: US 2005/0161924 A1
(43) Pub. Date: Jul. 28, 2005

(54) Gas generator

(75) Inventors: Georg Schoenhuber, Oberneukirchen (DE); Oskar Sponfeldner, Muehldorf (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Airbag Systems GmbH

(21) Appl. No.: 11/028,690

(22) Filed: Jan. 4, 2005

(30) Foreign Application Priority Data
Jan. 23, 2004 (DE) 20 2004 001 018.6

(51) Int. Cl. B60R 21/26

(52) U.S. Cl. 280/741

(57) ABSTRACT

A gas generator (10) for use in a safety arrangement for vehicles comprises a housing (30) having at least a first and a second housing part (32, 34), the first housing part (32) comprising a cover section (38) and the second housing part (34) defining at least partially a propellant chamber (22) containing a propellant (26) for generating a fluid. The first and the second housing part (32, 34), under the action of the fluid are movable from a state of rest, in which the first and second housing parts lie partially against each other, into an operating state, in which the first and second housing parts are spaced apart from each other to form an overflow opening (46) for the fluid. A balancing element (56) is arranged in the propellant chamber (26) and acts between said housing (30) and said propellant (26) to limit movement of said propellant in said housing. The balancing element (56) has a disc-shaped holding section (58) and an axially projecting marginal section (60) extending in the direction of the cover section (38). In the state of rest, the balancing element adjoins the second housing part (34). One or more spacer elements (64) originating from the marginal section of the balancing element rest against the cover section (38) to place the disc-shaped holding section (58) against the propellant (26).

### FIELD OF THE INVENTION

The invention relates to a gas generator for use in a safety arrangement for vehicles, comprising a housing in which a propellant chamber is defined, with a propellant contained in the propellant chamber for generating a fluid which is under pressure, and with a balancing element arranged in the propellant chamber for fixing the propellant, the housing having at least a first housing part with a cover section and a second housing part which defines the propellant chamber at least partially, and the first and the second housing part, under the action of the fluid under pressure, being movable from a state of rest in which they lie partially against each other, into an operating state in which they are spaced apart from each other and form an overflow opening for the fluid.

### BACKGROUND OF THE INVENTION

Such a gas generator is described for example in the U.S. Pat. No. 5,984,352, incorporated herein by reference. These gas generators are used in vehicle occupant restraint systems in order, for example, to inflate airbags or belt tensioners. If a sensor establishes that unusual acceleration values are present or if it detects an accident, then the ignition of a propellant take s place , whereby a fluid which is under pressure is released. In this operating state of the gas generator, the housing of the gas generator is deformable as a function of the pressure of the released fluid, the housing parts moving with respect to each other as a function of the pressure of the fluid and freeing an overflow opening or fluid passageway in the form of a ring gap. The flow cross-section of the overflow opening increases with the increasing pressure of the fluid and the fluid stream flows substantially completely through the overflow opening and further into the safety arrangement which is to be activated. The balancing element arranged in the housing exerts a pressure onto the propellant, which is generally present as a bulk material, and is intended to prevent the propellant from being able to move freely and to prevent clattering and rattling noises from occurring in the gas generator during travel.

### SUMMARY OF THE INVENTION

It is an object of the invention to improve the fixing of the propellant in variable initial positions, i.e. with a different filling level, in the state of rest of the gas generator, and of optimizing the outflow behavior of such a gas generator in the operating state.

According to the invention, a gas generator for use in a safety arrangement for vehicles is provided, said gas generator comprising:

a housing having at least a first and a second housing part, the first housing part comprising a cover section and the second housing part defining at least partially a propellant chamber containing a propellant for generating a fluid, wherein the first and the second housing part, under the action of the fluid are movable from a state of rest, in which the first and second housing parts lie partially against each other, into an operating state, in which the first and second housing parts are spaced apart from each other to form an overflow opening for the fluid; and

a balancing element arranged in the propellant chamber and acting between said housing and said propellant to limit movement of said propellant in said housing;

characterized in that the balancing element has a disc-shaped holding section and an axially projecting marginal section extending in the direction of the cover section and, in the state of rest, adjoining the second housing part; the balancing element further having one or more spacer elements originating from the marginal section and resting against the cover section to place the disc-shaped holding section against the propellant.

This means that the disc-shaped holding section of the balancing element covers the propellant substantially over the entire cross-section of the gas generator and the rigid marginal section extends from the holding section upwards towards the cover section of the first housing part, whilst the preferably flexibly constructed spacers, originating from the marginal section, rest against the first housing part. The rigid upright marginal section ensures that the balancing element remains substantially inherently stable in the operating state of the gas generator and does not place itself in front of the overflow opening thereby blocking the opening. Only the spacer elements can be pressed against the cover section in the operating state and bent onto the disc-shaped holding section. In the state of rest, when the gas generator is inactive, the spacer elements make possible a balancing of the propellant volume over a large range, because they are pre-stressed differently according to the filling level of the propellant on installation of the cover section and thus apply the disc-shaped holding section securely against the propellant in every position.

It is particularly advantageous if between the holding section and the marginal section, a transition section is present which has a convex curvature towards the propellant chamber. This leads to an optimization of the outflow behavior of such a gas generator, because in this case in the operating state of the gas generator, the fluid can be guided out from the propellant chamber past the convex curved transition section to the overflow opening. The risk of a blocking of the fluid stream out of the propellant chamber through the overflow opening is thus further reduced.

The disc-shaped holding section, the marginal section and the spacer elements are preferably formed in one piece with each other. This permits an economical manufacture and contributes to the strength of the component.

Preferably, the spacer elements are constructed as tongues which rest against the cover section of the first housing part. It is particularly preferable if these tongues are constructed so as to be elastic. Through these measures, on the one hand a saving of material is achieved, and on the other hand the balancing element can adapt itself particularly well to different filling levels of the propellant in the propellant chamber.

If the tongues are arranged approximately equidistant along the marginal section, then a uniform transmission of load takes place of the forces acting from the propellant onto the disc-shaped holding element to the first housing part. Thereby, a uniform filling level of the propellant bulk material in the propellant chamber is ensured.

In a further preferred embodiment, the gas generator has an igniter chamber with a cylindrical igniter chamber wall and the balancing chamber has a recess by means of which the balancing element is guided along the igniter chamber wall. Thereby, in the state of rest of the gas generator, a further lateral support of the balancing element is achieved and, in the operating state, a better guidance of the balancing element is ensured in its movement in the direction of the cover section, and its final position is clearly established.

### BRIEF DESCRIPTION OF THE DRAWINGS

Further features and advantages of the invention will be apparent from the following description of an example embodiment with reference to the enclosed drawings. In the drawings:

FIG. 1 shows a sectional view of a gas generator according to the invention in the state of rest;

FIG. 2 shows a sectional view of the gas generator according to the invention in the operating state;

FIG. 3 shows a perspective view of the balancing element of the gas generator according to the invention;

FIG. 4 shows a side view, in section, of the balancing element of the gas generator according to the invention; and

FIG. 5 shows a top view onto the balancing element of the gas generator according to the invention.

### DETAILED DESCRIPTION OF PREFERRED EMBODIMENTS

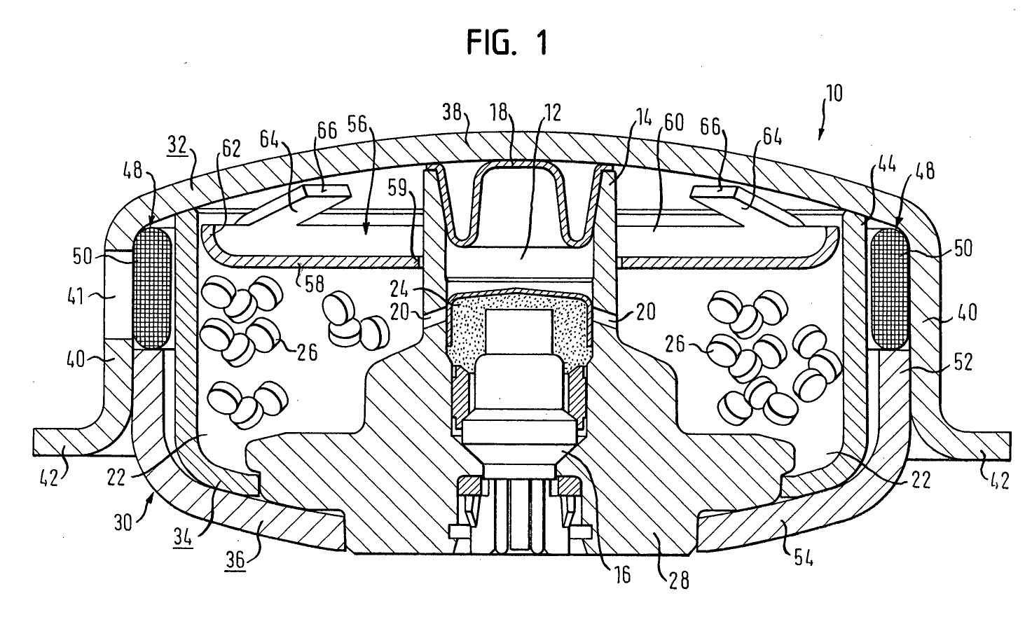

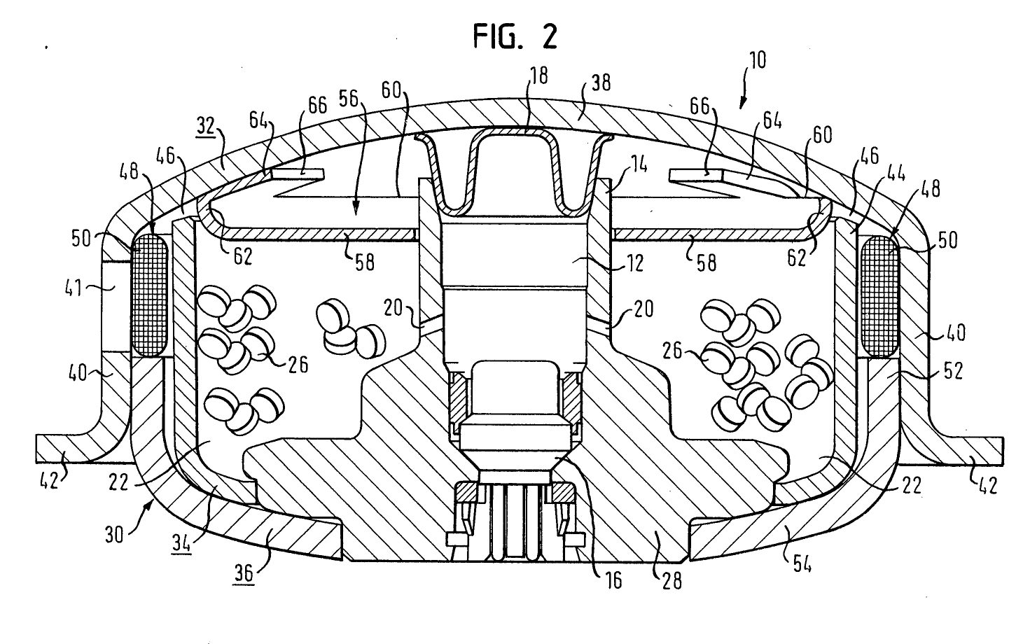

In FIGS. 1 and 2, a gas generator 10 is shown, which corresponds substantially in structure and basic function to the gas generator described in the U.S. Pat. No. 5,984,352.

FIGS. 1 and 2 show the gas generator 10 with a central igniter chamber 12 which is surrounded by an igniter chamber wall 14 and in which an igniter 16 is situated. Alternatively, the igniter chamber 12 can also have two igniters. Over the igniter 16, a cap 18 is arranged which is displaceable on the igniter chamber wall 14. In the igniter chamber wall 14 of the igniter chamber 12, channels 20 are situated, only two of which are illustrated. The channels 20 provide a connection between the igniter chamber 12 and a propellant chamber 22. Propellant 24, 26 is situated in the igniter chamber 12 and in the propellant chamber 22. The igniter chamber wall 14 is preferably connected in one piece with an igniter flange 28, in which the igniter 16 is fastened. The igniter 16 and the chambers 12, 22 are surrounded by a housing 30 having multiple parts.

The housing 30 is composed substantially from three housing parts 32, 34, 36. The first bell-shaped housing part 32 comprises a cover section 38, a wall section 40, delimiting the generator peripherally, with gas outlet openings 41, and a flange section 42 which can serve for fastening the gas generator 10 to a generator carrier (not illustrated).

The second housing part 34 is substantially a cylinder ring which delimits the propellant chamber 22 peripherally. In an end section 44 which it forms at its end facing the first housing part 32, the second housing part 34 in the state of rest (FIG. 1) lies closely against the cover section 38, whilst in the operating state of the gas generator 10 between end section 44 and cover section 38, an overflow opening 46 is formed (FIG. 2). Between the wall section 40 of the first housing part 32 and the second housing part 34, an outflow zone 48 is situated with a filter 50 through which a fluid connection is produced from the chambers 12, 22 to the gas outlet openings 41.

The third housing part 36 likewise has a cylindrical wall section 52 and a base section 54. The wall section 52 of the third housing part is arranged between the wall section 40 of the first housing part 32 and the second housing part 34 and connected at least partially with the wall section 40. The base section 54 forms a part of the underside of the gas generator 10 and receives the igniter flange 28 with the igniter 16.

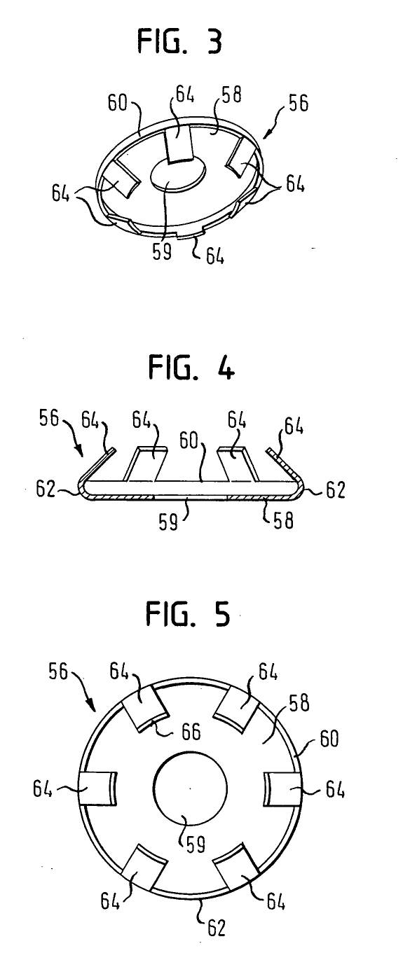

Between the propellant chamber 22 and the cover section 38, a balancing element 56 is arranged, which is to be explained below in detail with the aid of FIGS. 3 to 5.

The balancing element 56, which can consist of a plastic or of metal, has a disc-shaped holding section 58, for example in the form of a perforated disc, a wire mesh or of expanded metal and has a continuous encircling marginal section 60. The flat, gas-permeable holding section 58 is formed in a shape of a circular ring and is provided with a central recess 59. The marginal section 60 adjoins a transition section 62 originating from the holding section 58, which transition section 62 is curved in a convex shape towards the propellant chamber 22 (FIGS. 1 and 2) and extends axially in the direction of the cover section 38. In the embodiment illustrated here, adjoining the marginal section 60 are six tongue-shaped plates 64, which are arranged uniformly along the periphery of the marginal section 60, whereby the balancing element is given a radially symmetric construction. The tongues 64 have substantially a rectangular profile, are slightly curved and have, respectively, an edge 66 which owing to the slight curvature lies well against the cover section 38. The illustrated construction leads to a particularly uniform transmission of the forces of the propellant 26 in the propellant chamber 22 to the disc-shaped holding section 58 and from the latter via the tongues 64 to the cover section 38. Through the pre-stressing of the tongues, the propellant 26 is on the one hand reliably fixed, without rattling noises occurring in the gas generator 10; on the other hand, the balancing element 56, however, can also balance out different filling levels of the propellant 26 without difficulty. In addition, the pre-stressing of the tongues 64 can be varied in predetermined limits, whereby a further variation of the filling level of the propellant 26 in the propellant chamber 22 becomes possible. An elastic construction of the tongues 64 supports the filling level balancing over the entire lifespan of the gas generator.

The mode of operation of the gas generator is to be described below with the aid of FIGS. 1 and 2.

In FIG. 1 the state of rest is shown before activation of the gas generator; in FIG. 2 the state during the operation of the gas generator is shown. In the state of rest, the disc-shaped holding section 58 of the balancing element 56 lies on the propellant 26 and fixes the latter in the propellant chamber 22. The upwardly bent spacer elements or tongues 64 are brought into their final position through the installation of the first housing part 32 and rest against the cover section 38. Through the pre-stressing force of the spacer elements 64, the disc-shaped holding section 58 is pressed onto the propellant 26, thus securely fixing the propellant to limit any movement of the propellant in the housing so that no rattling noises can occur. The pre-stressing force can vary depending on the filling level of the propellant, so that a filling level balancing can be ensured over a wide range.

On activation of the igniter 16, the pressure in the igniter chamber 12 increases such that the cover section 38 of the first housing part 32 is raised by means of the cap 18. The first and second housing part 32, 34 now no longer form a common contact region. At the same time, the cap 18, which is now raised, frees the channels 20, whereby a flow connection is produced between the igniter chamber 12 and the propellant chamber 22. Gas and hot particles released from the propellant 24 flow over the channels 20 into the propellant chamber 22 and ignite the propellant 26. The propellant 26 burns off and generates a fluid or gas which is under high pressure in the propellant chamber. Through the high pressure in the propellant chamber 22, the balancing element 56 is raised, the tongues 64 which lie against the cover section 38 being deformed and the rigid, upright marginal region 60 coming into abutment against the cover section 38. On raising of the balancing element 56, its movement is guided by means of the recess 59 and the igniter chamber wall 14. As can be seen in FIG. 2, after activation of the gas generator 10, fluid can flow out from the propellant chamber 22 past the convex curved transition section 62 through the overflow opening 46 on to the outflow region 48 with the filter 50. Then the released gas can leave the gas generator 10 via the gas outlet openings 41 and flow into an airbag or into another vehicle occupant protection arrangement (not illustrated). The particular construction of the balancing element 56 with the axially projecting marginal region and the tongues 64 prevents the overflow opening 46 from being blocked and prevents the passage of the fluid to the outflow region 48 from being impeded.

1. A gas generator (10) for use in a safety arrangement for vehicles, said gas generator comprising:
a housing (30) having at least a first and a second housing part (32, 34), the first housing part (32) comprising a cover section (38) and the second housing part (34) defining at least partially a propellant chamber (22) containing a propellant (26) for generating a fluid, wherein the first and the second housing part (32, 34), under the action of the fluid are movable from a state of rest, in which the first and second housing parts lie partially against each other, into an operating state, in which the first and second housing parts are spaced apart from each other to form an overflow opening (46) for the fluid; and
a balancing element (56) arranged in the propellant chamber (26) and acting between said housing (30) and said propellant (26) to limit movement of said propellant in said housing;
characterized in that the balancing element (56) has a disc-shaped holding section (58) and an axially projecting marginal section (60) extending in the direction of the cover section (38) and, in the state of rest, adjoining the second housing part (34); the balancing element (56) further having one or more spacer elements (64) originating from the marginal section and resting against the cover section (38) to place the disc-shaped holding section (58) against the propellant (26):

2. The gas generator (10) according to claim 1, wherein a transition section (62) is formed between the marginal section (60) and the disc-shaped holding section (58), the transition section having a convex curvature towards the propellant chamber (22).

3. The gas generator (10) according to claim 1, characterized in that the spacer elements (64) are constructed so as to be elastic.

4. The gas generator (10) according to claim 1, characterized in that the spacer elements are constructed as tongues (64).

5. The gas generator (10) according to claim 1, characterized in that the spacer elements (64) are arranged approximately equidistant along the marginal section (60).

6. The gas generator (10) according to claim 1, characterized in that the spacer elements (64) have substantially a rectangular profile.

7. The gas generator (10) according to claim 1, characterized in that the balancing element (56) is constructed so as to be radially symmetrical.

8. The gas generator (10) according to claim 1, characterized in that the disc-shaped holding element (58), the marginal section (60) and the spacer elements (64) are integrally formed with each other.

9. The gas generator (10) according to claim 1, characterized in that the gas generator (10) further comprises an igniter chamber (12) having a cylindrical igniter chamber wall (14), and the balancing element (56) has a recess (59) guiding the balancing element (56) along the igniter chamber wall (14).

10. The gas generator (10) according to claim 1, characterized in that the balancing element (56) consists of plastic.

11. The gas generator (10) according to claim 1, characterized in that the balancing element (56) consists of metal..

12. The gas generator according to claim 1, characterized in that the disc-shaped holding section (58) is gas-permeable.

13. The gas generator according to claim 1, characterized in that the marginal section is constructed so as to be continuously encircling.
